(19) United States
(12) Patent Application Publication
(10) Pub. No.: US 2010/0183447 A1
(43) Pub. Date: Jul. 22, 2010

(54) DIGITAL OVER SPEED CIRCUIT

(76) Inventors: Peter Moskun, Baie d'Urfe (CA); Bernard Gravel, Kirkland (CA)

Correspondence Address: Gerald M. Bluhm;Tyco Safety Products, 50 Technology Drive, Westminster, MA, 01441-0001, US

(21) Appl. No.: 12/690,613

(22) Filed: Jan. 20, 2010

Related U.S. Application Data
(60) Provisional application No. 61/145,804, filed on Jan. 20, 2009.

(51) Int. Cl. F04B 49/06; F02P 9/00

(52) U.S. Cl. 417/34; 123/335

(57) ABSTRACT

The present embodiments relate to a digital over speed circuit including a controller configured to calculate the speed of an engine and shut down the engine electronically when an over speed condition exists. The digital over speed circuit may be easily installed by the end user. Only a single wire is needed between the digital over speed circuit and the engine. Further, the digital over speed circuit does not require a reset or any user action of any kind after the over speed condition has been detected and power removed from the engine. In other words, there is no ON switch, and the user may immediately start the engine again after the engine has stopped and the digital over speed circuit has reset.

### CROSS-REFERENCE TO RELATED APPLICATIONS

This application claims the benefit of U.S. Provisional Application Ser. No. 61/145,804, filed Jan. 20, 2009, which is herein incorporated by reference in its entirety.

### BACKGROUND

In forest fire operations, specialized equipment is used to contain, fight and extinguish fires. One of the staple pieces of equipment used in forest fire operations is a portable fire pump. A portable fire pump must be robust, durable and reliable as it is subjected to harsh environments, abuse due to transport, and operator misuse. If the fire pump fails and ceases to be operational, the chance of controlling the fire is greatly reduced, allowing the fire to spread rapidly and endangering the fire fighter's life.

One common failure associated with fire pumps is an over speed condition. An over speed condition occurs when the pump end portion of the fire pump experiences a loss of prime. A loss of prime occurs when there is little or no water in the pump. This can be attributed to leaks on the suction side of the pump, leaks in the suction hose, waves causing the suction hose to rise out of the water momentarily or a lack of water at the water source. A loss of prime severely unloads the engine and causes the engine to race to speeds outside the safe operating parameters of the engine.

If the engine is permitted to over speed, engine damage and pump end damage will occur, rendering the fire pump inoperable. Some engines have governors which will govern the maximum speed. However, during a loss of prime, unless the engine is stopped, the pump end will run dry and damage will occur to the pump end seal caused by a lack of water lubrication. Other engines use a mechanical cut-out switch which is tripped by the increased cooling air pressure due to the cooling fan rotating faster at over speed conditions. Once tripped, the mechanical cut-out switch must be manually reset to the operative position and then the engine may be manually restarted. Further, mechanical switches have problems with reliability and accuracy.

What is needed is a digital over speed switch with improved reliability and accuracy that does not require a manual restart and can be installed easily by the end user.

### SUMMARY

A digital over speed circuit for monitoring a speed of an engine includes a communication path that electrically connects the digital over speed circuit to the engine, a controller configured to calculate the speed of the engine from a signal received via the communication path and generate a shut-off signal, and a shut-off circuit that receives the shut-off signal and shuts off the engine using the communication path.

The digital over speed circuit may derive power from a powering circuit that converts an analog signal received from the communication path to a power signal. The derived power may power some or all of the digital over speed circuit, including the controller in the digital over speed circuit. The digital over speed circuit generates the shut-off signal if the speed of the engine meets or exceeds a predetermined maximum speed value. Further, the digital over speed circuit may generate the shut-off signal based on a user input, such as a user inputting a command to shut-off the engine via a shut-off switch. The shut-off signal may trigger a relay or other switch to connect the communication path to ground, which removes power to the engine thereby shutting off the engine.

Because a single communication path carries the communications in either direction between the digital over speed circuit and the engine, the only electrical connection between the digital over speed circuit and the engine may be a single conductive path (such as a single wire). In addition, a screw or bolt that mechanically secures the digital over speed circuit to the engine may provide a path to ground. In this way, the assembly of the digital over speed circuit to the engine is simple.

Further, because the shut-off signal is generated electronically (as opposed to mechanically), no reset levers or ON switches are required. In other words, no intermediate steps are required after an over speed condition shut-off before the user may start the engine again.

### BRIEF DESCRIPTION OF THE DRAWINGS

FIG. 1 illustrates a block diagram of a digital over speed circuit.

FIGS. 2A and 2B illustrate a circuit diagram of another implementation of the digital over speed circuit.

FIG. 3 is a flow diagram of the operation of the digital over speed circuit.

### DETAILED DESCRIPTION

The present embodiments relate to a digital over speed circuit including a controller configured to calculate the speed of an engine and shut down the engine electronically when an over speed condition exists. The digital over speed circuit may be easily installed by the end user. Only a single wire is needed between the digital over speed circuit and the engine. Further, the digital over speed circuit does not require a reset or any user action of any kind after the over speed condition has been detected and power removed from the engine. In other words, there is no ON switch, and the user may immediately start the engine again after the engine has stopped and the digital over speed circuit has reset.

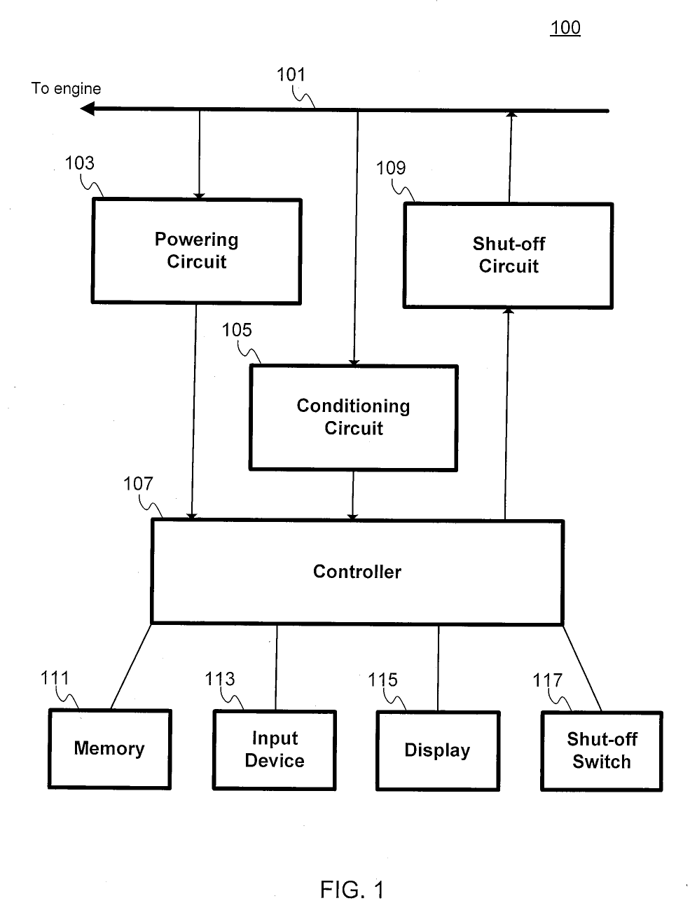

FIG. 1 illustrates a block diagram of a digital over speed circuit 100. The digital over speed circuit 100 may include a controller 107, a powering circuit 103, a conditioning circuit 105, and a shut-off circuit 109. The over speed circuit 100 may further include one or more of memory 111, input device 113, display 115, and a shut-off switch 117 (such as a manual shut-off switch). However, the elements depicted in FIG. 1 are merely for illustration purposes only.

The digital over speed circuit may be used with a variety of engines, such as an engine of the type used in a water pump. A single communication path 101 may connect the digital over speed circuit 100 to the engine. The communication path 101 may be a single wire. The communication path 101 is connected to the primary winding of a magneto that drives a spark plug of the engine.

The digital over speed circuit 100 may derive power from a signal received via the communication path 101. Alternatively, the digital over speed circuit 100 may have an alternative power source, such as a battery. The digital over speed circuit 100 calculates the speed of the engine from the signal received via the communication path 101. The digital over speed circuit 100 shuts down the engine by grounding the communication path 101. In this way, the communication path 101 may provide all of the inputs and outputs to the digital over speed circuit 100.

Using only a single communication path 101 provides several advantages. First, installation is simplified. Installation may be as simple as securing the digital over speed circuit 100 using one or more bolts and attaching a single wire to provide the communication path 101. Second, no secondary power supply, such as a battery, is needed. Third, because the digital over speed circuit 100 is powered solely from the engine, no ON switch is required, thereby simplifying operation. The digital over speed circuit 100 may simply become active again the next time the engine is cranked.

In a single cylinder, two stroke engine, every spark that is generated equates to one revolution of the crankshaft, which relates to the speed of the engine. The engine uses the magneto to provide the high voltage that leads to the spark plug, resulting in a spark to ignite the fuel and air mixture. The magneto is made up of a primary coil and a secondary coil. The primary coil generates a low voltage signal, which induces a high voltage signal being generated in the secondary coil. It is therefore possible to count the low voltage signal at the primary coil to determine the engine speed. The communication path 101 may thus be connected to a primary winding of the magneto that drives a spark plug of the engine.

The signal received from the primary winding of the magneto via the communication path 101 is an analog signal that may have a peak-to-peak amplitude of approximately 160 volts. The analog signal may also be very noisy. Conditioning circuit 105 filters and conditions the analog signal from the primary coil of the magneto to produce a digital signal that may be input to the controller 107.

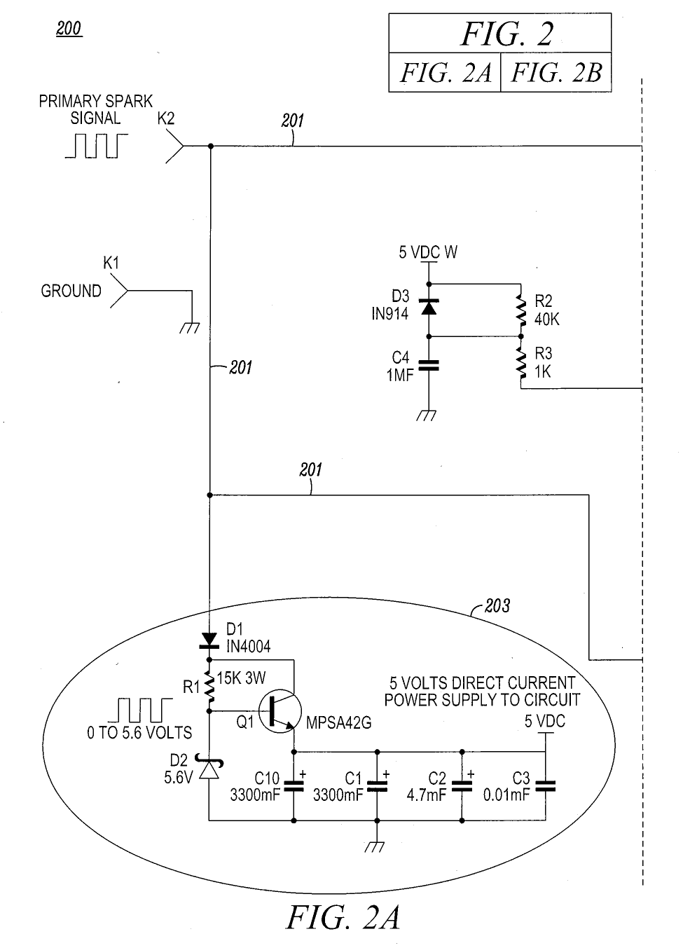

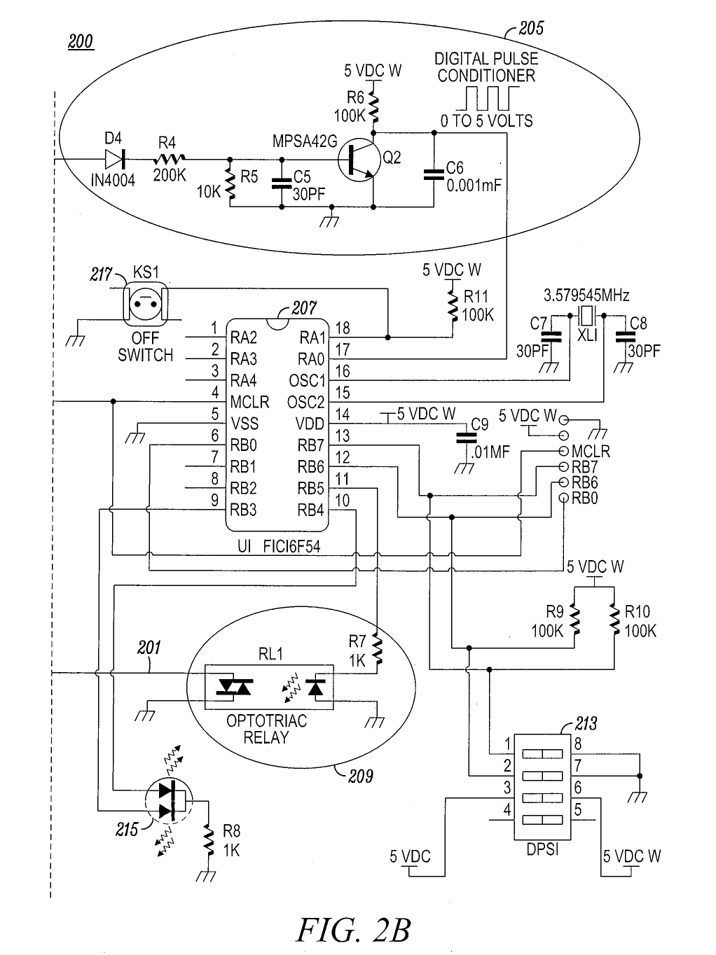

Powering circuit 103 supplies power to the controller 107. The powering circuit 103 receives the analog signal from the primary coil of the magneto. The powering circuit 103 rectifies and regulates the analog signal to produce a DC signal (such as 5 volt) to supply power to the controller 107 as well as other portions of the digital over speed circuit discussed below with reference to FIGS. 2A and 2B.

The controller 107 may be a microcontroller. For example, in one embodiment, the controller 107 may be a Flash-Based, 8-Bit CMOS Microcontroller, such as a PIC16F54 device. Alternatively, controller 107 may be implemented as a processor, which may be a general purpose processor or microprocessor, a digital signal processor (DSP), an application-specific integrated circuit (ASIC), programmable logic arrays, a Field Programmable Gate Arrays (FPGA), integrated as a “System-On-Chip,” or any other digital device capable of processing.

The controller 107 receives the conditioned signal. The conditioned signal is counted over a time period. The controller 107 will then calculate the count per unit time and compare the result to a set point stored in memory. The memory may store an indication of the set point, which corresponds to a predetermined maximum allowable speed value. Exemplary maximum speed values include 7000 RPM, 7500 RPM, or 8000 RPM, but any maximum speed values may be used.

If the calculated speed is greater than or equal to the predetermined maximum speed value stored in memory, a shut-off signal will be sent to the shut-off circuit 109. When the calculated speed is greater than or equal to the predetermined maximum speed, an over speed condition in the engine exists.

The predetermined maximum speed value may be stored in memory 111. Memory 111 may be external or internal to controller 107. Memory 111 may comprise, for example, an electronic erasable program read only memory (EEPROM), flash memory, or static random access memory (RAM). The predetermined maximum speed may pre-programmed at the factory (or prior to beginning use of the digital over speed circuit 100). Or, the predetermined maximum speed may be programmed via input device 113, as discussed below.

When an over speed condition exists and the controller 107 sends a shut-off signal to the shut-off circuit 109, the shut-off circuit 109 grounds the primary coil of the magneto, which inhibits the induction of a high voltage in the secondary coil. If no high voltage is produced then no spark will occur at the spark plug, inhibiting fuel ignition.

The shut-off circuit 109 continues to ground the primary coil of the magneto until the remaining energy powering the controller 107 has dissipated. Once the remaining energy has dissipated, the shut-off circuit 109 will revert back to an open biased circuit ready for the next subsequent start. Unlike mechanical cutoff switches, the digital over speed circuit 100 automatically reverts back to the ON state. In other words, no ON switch or user intervention or input is required after the engine has been shut off before the engine can be restarted by the user.

However, the digital over speed circuit may utilize an integral shut-off switch 117. When the shut-off switch 117 is activated, the input to the controller 107 connected to the shut-off switch 117 will change state (e.g.: low to high), which causes the controller 107 to override the actual condition, sending the shut-off signal to the shut-off circuit 109 regardless of the calculated speed of the engine. Alternatively, the shut-off switch 117 may be directly connected to the shut-off circuit 109 rather than controller 107, which would allow it to directly ground the primary coil of the magneto.

Because of the ease of installation and the one wire design, the digital over speed circuit may be designed as a retrofit that can be installed on a fire pump by the end user. The user can simply remove the existing ON/OFF switch and mechanical cut-out switch from the pump and connect the digital over speed circuit 100 to the stop switch wire. The digital over speed circuit 100 may also be physically secured to the engine, such as by using screws and lock washers, in such a way that a path to ground is provided through the electrically conductive casing of the digital over speed circuit 100 to a frame of the engine.

In the case where the digital over speed circuit 100 is a retrofit that can be installed on existing fire pumps, the predetermined maximum speed value is known and stored, for example, in memory 111. In another embodiment, the digital over speed circuit 100 may be configured for use on different engines, which may have different operating parameters.

Some engines are able to run safely at much higher engine speeds while other engines run safely at lower engine speeds. The memory 111 may include a plurality of stored presets that the user will be able to select depending on the safe operating speed of the engine. The stored presets may be selected or defined through the use of manual switches, a computer link, or a wireless transmitter. For example, a user input device 113 allows the user to select the predetermined maximum speeds. The user input device 113 may be a set of dip switches that allow the user to enter a code that corresponds to a particular model of fire pump or engine. In addition, the dip switches may allow the user to enter a code that corresponds to a particular maximum speed. Alternatively, the user input device 113 may comprise a keyboard or other similar type of input device.

Alternatively, the dip switches may allow the user to fine tune or make small adjustments to the predetermined maximum speed value. During the lifetime of a pump or engine, the optimal maximum speed value may change. For example, the condition of the engine can change based on wear to the piston rings, cylinder, bearings, ignition timing, or muffler and the condition of the pump end may change due to wear on the seal and bearings. Small adjustments in the predetermined maximum value may be made by the user via input device 113 to account for changes in the condition of the engine or pump end. Controller 107 may also be configured to detect changes in the condition of the engine or pump end based on the operation of the engine and automatically adjust the maximum speed value accordingly.

In addition, the engine or pump end may perform differently at different elevations or different weather conditions. The user input device 113 may include one or more switches based on weather or altitude for the user to select, and controller 107 may be configured to make the appropriate adjustment to the predetermined maximum speed value.

In any case, the controller 107 will calculate the engine speed and compare the calculated speed to the predetermined maximum speed value as adjusted or defined by the user input device 113. If the calculated engine speed is greater than or equal to the predetermined maximum speed value, the magneto will be grounded and the engine will be shut down.

The user input device 113 may also allow the user to select the type of engine. For example, four stroke engines produce one pulse for every two revolutions of the crankshaft. The user input device 113 may provide an input to controller 107 that indicates that the digital over speed circuit 100 is installed on a four stroke engine and every pulse equals to two revolutions of the crankshaft. In this way, one or more parameters regarding the engine (such as the type of engine) may be input via the user input device 113.

In another example, some engines may have a true double pulse such that two pulses are generated and sent to the spark plug for every revolution of the crankshaft. Accordingly, the user input device 113 may provide an input to controller 107 indicating that the digital over speed circuit 100 is installed on an engine that produces a double pulse, and the calculations of the controller 107 are adjusted accordingly.

Conditioning circuit 105 filters and conditions the analog signal from the primary coil of the magneto to produce a digital signal that may be input to the controller 107. However, the quality of the signal will vary due to the amount of noise between the pulses. The controller 107 may employ additional filtering techniques so that the controller 107 reads only the pulses and disregard the noise in between the pulses.

This can be achieved by using filtering techniques including, but not limited to debouncing algorithms, which in essence cause controller 107 to ignore the signal noise in between the pulses therefore giving a true calculation of the engine speed. Most of the noise may occur just after the transition of the pulse from low to high or vice versa. Controller 107 may be configured to wait a time period after the transition of a pulse before it will accept the next transition. The time period is smaller than the smallest possible time between actual pulses. The time period is based on the maximum engine speed (measured at shut-off—when the nozzle is closed) and includes a buffer zone. The time period may be predetermined or adjustable. When a pulse is detected, a counter starts. If the next pulse arrives too soon (shorter than the time period), it is regarded as noise and is discarded.

In one embodiment, or with certain types of engines, the user will be able to choose between presets that have a particular program debounce time period and maximum speed value pertaining to a particular engine. In another embodiment, the digital over speed circuit 100 may be configured to communicate, through a computer link or a wireless transmitter, with a computer. The computer may upload a modified program, debounce time period, or maximum speed value according to the particular engine and quality of the signal.

The digital over speed circuit 100 may also include a display 115. The display 115 may be a liquid crystal display (LCD). Alternatively, display 115 could be a system of light emitting diodes and/or seven segment displays. The display 115 may be configured to display one or more of the speed of the engine, the maximum allowable speed value, the maximum speed of the engine (within a predetermined time period, such as the last 5 minutes), a running time, and a service message.

As discussed above, controller 107 calculates the speed of the engine and accesses the maximum speed value from either memory 111 or user input device 113. The controller 107 may also communicate the speed of the engine and/or the maximum speed value to display 115. In one embodiment the controller 107 may instruct the display 115 to flash the maximum speed value when the digital over speed circuit 100 is powered up and then display the speed of the engine thereafter.

The controller 107 may also include an hour meter. The hour meter records the running time of the engine or fire pump. Alternatively, the hour meter may record the running time of controller 107. Between operations, memory 111 may store the current running time. From the running time, controller 107 may also calculate various service messages to remind the user of maintenance tasks and communicate those messages to display 115. For example, one service message may indicate the need for an oil change and another may indicate the need to change the spark plug(s). The service messages are generated based on the running time of the engine or alternately, the running time of the microcontroller 107. For example, a particular service message may be triggered every 20 hours of running time.

In one embodiment, the hour meter starts when the engine speed is above a predetermined speed. The predetermined speed may be above cranking speed but lower than the idle speed of the engine. In this way, the running time will be recorded when the engine is running and not during the starting of the engine or when the engine is shutting down. The hour meter could operate during shut down because the controller 107 still has enough stored power to operate for a short period of time after the engine has stopped. Further, operating the hour meter after the starting of the engine provides the controller 107 sufficient time to properly power up before data is written, which potentially prevents data corruption.

When an over speed condition is detected and power is removed from the engine, the display 115 may remind the user of the possible causes of the over speed condition. For example, controller 107 may instruct the display 115 to display a message that reminds the user to check the suction hose, check a foot valve strainer, check the level of the water source, re-prime the pump, etc.

FIGS. 2A and 2B illustrate a circuit diagram of another implementation of a digital over speed circuit 200. The circuit diagram is merely for illustrative purposes. Much of the operation and function of the digital over speed circuit 200 is similar to that of digital over speed circuit 100 discussed above.

Communication path 201 connects powering circuit 203, conditioning circuit 205, and a shut-off circuit 209 with the primary winding of the magneto that powers the spark plug of the engine. A controller 207 is also connected to powering circuit 203, conditioning circuit 205, and a shut-off circuit 209.

The powering circuit 203 includes transistor Q1, diode D1, Zener diode D2, resistor R1, and capacitors C1, C2, C3, and C10. The conditioning circuit includes transistor Q2, diode D4, resistors R4, R5, and R6, and capacitors C5 and C6. The shut-off circuit includes relay RL1 and resistor R7.

The digital over speed circuit may also include a display 215, a shut-off switch 217, and an input device 213. In addition, oscillator XL 1 and capacitors C7 and C8 provide a clock signal to controller 207. Power-on reset circuit, includes a diode D3, capacitor C4, and resistors R2 and R3.

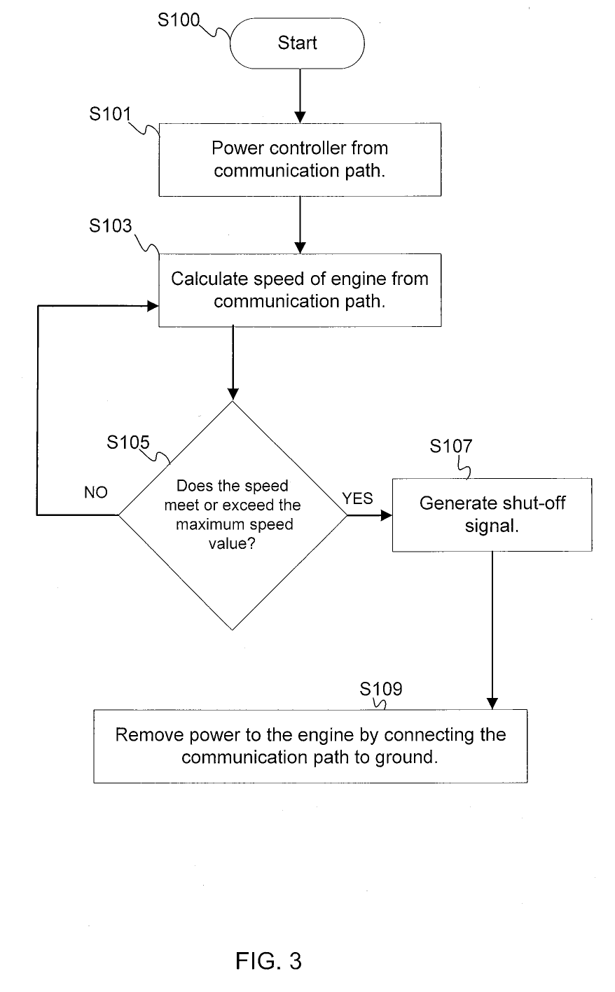

FIG. 3 is a basic flow diagram of the operation of digital over speed circuit 100 or digital over speed circuit 200. In one embodiment, when controller 107, 207 is a processor, memory 111 may include instructions that are run by the processor to perform the steps of the flow diagram of FIG. 3.

The process begins at step S 100, the digital over speed circuit 100, 200 activates when the engine is cranked and power is provided via the communication path 101, 201 and powering circuit 103, 203. At step S103 controller 107, 207 calculates the speed of the engine from a signal received via the communication path 101, 201 and conditioning circuit 105, 205. At step S105, the controller 107, 207 determines whether the speed meets or exceeds the maximum speed value.

If the speed does not meet or exceed the maximum speed value, the process returns to step S 103. If the speed does meet or exceed the maximum speed value, the controller 107, 207 generates a shut-off signal. At step S109, the shut-off circuit removes power to the engine by connecting the communication path 101, 201 to ground.

Thus, particular embodiments of the invention have been described. Other embodiments are within the scope of the following claims. For example, the actions recited in the claims can be performed in a different order and still achieve desirable results.

What is claimed is:

1. A digital over speed circuit for monitoring a speed of an engine, comprising:
a communication path that electrically connects the digital over speed circuit to the engine;
a controller configured to calculate the speed of the engine from a signal received via the communication path and generate a shut-off signal; and
a shut-off circuit that receives the shut-off signal and shuts off the engine using the communication path.

2. The digital over speed circuit of claim 1, further comprising:
a powering circuit that converts an analog signal received from the communication path to a power signal that powers the controller.

3. The digital over speed circuit of claim 1, wherein the controller generates the shut-off signal if the speed of the engine meets or exceeds a predetermined maximum speed value.

4. The digital over speed circuit of claim 3, further comprising:
a memory storing the predetermined maximum speed value for the engine, wherein the controller compares the speed of the engine with the predetermined maximum speed value for the engine.

5. The digital over speed circuit of claim 3, further comprising:
a user input device configured to define an adjustment value to be applied to the predetermined maximum speed value.

6. The digital over speed circuit of claim 1, wherein the signal originates in a primary winding of a magneto that drives a spark plug of the engine.

7. The digital over speed circuit of claim 6, further comprising:
an electrically conductive casing,
wherein the shut-off circuit removes power to the engine by grounding the primary winding of the magneto through the communication path and the electrically conductive casing to a frame of the engine.

8. The digital over speed circuit of claim 1, wherein the controller calculates the speed of the engine by using a filtering algorithm that disregards a pulse as noise when the pulse occurs before a predetermined time period from a previous pulse has elapsed.

9. The digital over speed circuit of claim 6, wherein the communication path is the only electrical connection between the digital over speed circuit and the spark plug of the engine.

10. The digital over speed circuit of claim 6,
a user input device configured to select whether the controller calculates one revolution of the engine for every pulse in the primary winding of the magneto or calculates two revolutions of the engine for every pulse in the primary winding of the magneto.

11. The digital over speed circuit of claim 1, further comprising:
a display configured to display at least one of the speed of the engine, the maximum allowable speed value, a running time, and a service message.

12. The digital over speed circuit of claim 1, further comprising:
a manual shut-off switch that generates the shut-off signal and sends the shut-off signal to the grounding circuit, wherein the grounding circuit removes power to the engine when the shut-off signal is received.

13. The digital over speed circuit of claim 1, wherein the communication path consists of a single conductive path.

14. A method of monitoring a speed of an engine, the method comprising:
connecting a digital over speed circuit to the engine with a communication path;
calculating the speed of the engine from a signal received at a controller from the communication path; and
generating a shut-off signal that shuts off the engine using the communication path in response to at least one condition.

15. The method of claim 14, further comprising:
powering the controller from the communication path.

16. The method of claim 14, wherein the at least one condition comprises a manual shut-off; and
wherein the controller generates the shut-off signal based on a manual shut-off switch.

17. The method of claim 14, wherein the at least one condition comprises an over speed condition; and
wherein the controller generates the shut-off signal if the speed of the engine meets or exceeds a predetermined maximum allowable speed.

18. The method of claim 17, further comprising:
storing an indication of the predetermined maximum allowable speed value for the engine in a memory.

19. The method of claim 17, further comprising:
receiving an adjustment value from a user input device, wherein the adjustment value is to be applied to the predetermined maximum allowable speed value.

20. The method of claim 14, wherein the controller calculates the speed of the engine by counting pulses in a primary winding of a magneto that drives a spark plug of the engine.

21. The method of claim 20, wherein the shut-off signal shuts off the engine using the communication by grounding the primary winding of the magneto through the communication path to a frame of the engine.

22. The method of claim 14, further comprising:
displaying at least one of the speed of the engine, the predetermined maximum speed value, a running time, and a service message.

23. The method of claim 14, wherein the communication path consists of a single wire.

24. A system comprising an engine for use with a water pump and a digital over speed circuit, the system comprising:
a magneto that drives a spark plug of the engine;
a communication path that electrically connects the digital over speed circuit to the magneto;
a powering circuit that converts an analog signal received from the communication path to a power signal;
a controller powered by the power signal, the controller configured to calculate the speed of the engine from a signal received via the communication path and generate a shut-off signal; and
a shut-off circuit that receives the shut-off signal and shuts off the engine using the communication path.
